(19) United States
(12) Patent Application Publication
(10) Pub. No.: US 2006/0284073 A1
(43) Pub. Date: Dec. 21, 2006

(54) Method and apparatus for analysing combustion products

(76) Inventors: Quirinus Adrianus Sprinkhuizen, Hague (NL); Marinus Arnoldus Wilhelmus Van Der Zalm, Den Hoom (NL); Johan Hendrik Wagemaker, Delft (NL)

Correspondence Address: HAYNES AND BOONE, LLP, 901 MAIN STREET, SUITE 3100, DALLAS, TX, 75202, US

(21) Appl. No.: 10/563,036

(22) PCT Filed: Jul. 2, 2004
(86) PCT No.: PCT/EP04/07209

§ 371 Date: May 15, 2006

(30) Foreign Application Priority Data
Jul. 3, 2003 (NL) NL 1023809

(51) Int. Cl. H01J 49/00

(52) U.S. Cl. 250/288

(57) ABSTRACT

A method of analysing a sample, such as a fuel, comprises feeding the sample to a combustion chamber 2, the at least partial combustion of the sample in the combustion chamber 2 to form combustion products, the removal of the combustion products from the combustion chamber 2, the feeding of the combustion products to a measuring chamber 16,30 and the measurement of a component of the combustion products in the measuring chamber 16,30. The combustion products are removed from the combustion chamber 2 to a reservoir 15 in which the combustion products are collected, after which the collected combustion products are fed out of the reservoir 15 to the measuring chamber 16,30. An analysis device 1 with which the above method may be used is also disclosed.

The invention relates to a method of analysing a sample, such as a fuel, and an analysis device therefor.

A typical method of analysing a sample involves combusting the sample and investigating products of that combustion, by the following steps: feeding the sample to a combustion chamber, the at least partial combustion of the sample in the combustion chamber to combustion products, the removal of the combustion products from the combustion chamber, the feeding of the combustion products to a measuring chamber and the measurement of a component of the combustion products in the measuring chamber.

Such a method is disclosed in NL 1.007.860. This analysis method plays an important role in compliance with environmental regulations and is used, inter alia, to determine the sulphur content and/or nitrogen content of drinking water, ground water and waste water, sludge and of hydrocarbons such as petrol or kerosene, and other biological and chemical products. The analysis of a product may also relate to components other than sulphur (S) and nitrogen (N), such as chlorine (Cl) and carbon (C).

The product to be analysed may contain sulphur (S), nitrogen (N), chlorine (Cl) and/or carbon (C). During the combustion of said product in an oxygen-rich environment, SO₂, NOₓ, H⁺Cl⁻ and CO₂ may be produced. The quantity of SO₂, NOₓ, H⁺Cl⁻ and/or CO₂ that has been formed after combustion provides a measure of the quantity of S, N, Cl and C, respectively, that was present in the product prior to combustion. By measuring the molecules of the compounds SO₂, NOₓ, H⁺Cl⁻ and/or CO₂ after combustion, the sulphur (S), nitrogen (N), chlorine (Cl) and/or carbon (C) content, respectively, of the product can be recovered.

The measuring chamber is equipped to measure a certain component of the combustion products. Sulphur dioxide (SO₂) has the property of fluorescing as a result of irradiation with ultraviolet light (UV light). A measuring chamber for SO₂ therefore has a UV light source and a light sensor for measuring light emitted by SO₂. The SO₂ formed by combustion is injected into the measuring chamber and brought to an excited state, for example, by means of pulsating UV light from the light source. Said state is unstable and the excited SO₂ will very quickly fall back to its ground state. In this process, energy is released in the form of UV light. This released UV light can be measured with the light sensor, such as a UV-fluorescence detector. The amount of light emitted corresponds to the amount of SO₂, which is in turn a measure of the amount of sulphur (S) present in the sample.

A measuring chamber for measuring the nitrogen content (N) of a sample has a light sensor, while ozone is added to the combustion products just upstream of the measuring chamber. During the combustion of a nitrogen-containing sample, both nitrogen dioxide (NO₂) and nitrogen monoxide (NO) are formed. A so-called NO converter first converts all the NO₂ into NO. Then ozone (O₃) is added just upstream of the measuring chamber. The nitrogen monoxide (NO) reacts with the ozone (O₃), in which process nitrogen dioxide is formed in an excited state (NO₂*). Said excited state is unstable and the NO₂* will immediately fall back to its ground state. While falling back, light is emitted. In the reaction equation:
NO+O₃→NO₂*
NO₂*→NO₂+hν

The light sensor, such as a chemiluminescence detector, in the measuring chamber measures the amount of light. The amount of light emitted during the above de-excitation process is a measure of the amount of NO and that again corresponds to the amount of nitrogen (N) present in bound form in the sample.

The amount of chlorine (Cl) present in a sample may be measured by means of a coulometric determination. During the combustion of the sample, hydrogen chloride (H⁺Cl⁻) is formed. The combustion gases containing said H⁺Cl⁻ are passed through a titration cell containing, for example, silver ions (Ag⁺). An electric current flows through said titration cell. The Cl⁻ will react with the silver ions (Ag⁺) and precipitate. As a result of the decrease in the number of silver ions, the electric current will decrease. The titration cell will compensate for this reduction by producing Ag⁺. The amount of silver ions (Ag⁺) produced is a measure of the amount of chloride in the combustion gases, which again corresponds to the amount of chlorine (Cl) in the sample.

Incidentally, sulphur dioxide can also be determined coulometrically. In this case, the sulphur dioxide (SO₂) reacts with iodide (I₃⁻) present in the electrolyte of a titration cell. The electric current flowing through the cell will decrease as a result of the decrease in the amount of iodide. For that reason, the cell will start to produce iodide. The amount of iodide produced is a measure of the amount of sulphur dioxide (SO₂) in the combustion gases. Again, the amount of sulphur dioxide corresponds to the amount of sulphur (S) that is present in bound form in the product.

As a result of combustion, carbon (C) in the sample may lead to carbon dioxide (CO₂). Carbon dioxide (CO₂) has the property of absorbing infrared radiation (IR radiation). A so-called NDIR (non-dispersive IR) detector, for example, is therefore fitted in a measuring chamber for measuring the carbon content of a sample. In this process, a light source transmits an infrared light beam through a rotating gas filter having various chambers that are alternately filled with carbon dioxide (CO₂) and nitrogen (N₂). Each CO₂ chamber provides a reference signal by completely absorbing the infrared beam, so that it is not absorbed by the carbon dioxide (CO₂) from the combustion gases within the measuring chamber. The N₂ chamber transmits the infrared beam. The carbon dioxide (CO₂) present in the measuring chamber will then absorb the infrared beam, in which process a measurement signal is produced. The ratio between the reference signal and the measurement signal is a measure of the amount of carbon dioxide (CO₂) in the combustion gases. The number of CO₂ molecules in the combustion gases again corresponds to the amount of carbon (C) in the sample.

In addition, the measuring chamber may be equipped for measuring a component other than nitrogen, sulphur, chlorine or carbon. In particular, it is possible to place a plurality of measuring chambers one behind the other, for the measurement of various combustion components.

Generally, environmental regulations set limits or specifications for the amount of various substances or components that can be present in a product. Such limits are becoming ever lower. This means that the permitted amount of sulphur or nitrogen or another component in a product is ever smaller. To check whether a product conforms to the limits or specifications, the amount of the respective component in a sample of the product is measured, by a known method, with respect to a zero line (reference line). The zero line is formed by a basic, background flow of nitrogen and/or an inert gas, such as argon, that flows continuously through the device. The basic flow provides reference conditions in the measuring chamber during each measurement of a component of the combustion products from a sample.

However, the zero line tends to suffer from noise as a consequence of fluctuations in the basic flow. The ever stricter regulations being imposed on trace substances in products mean that some measurements are so small that they are insufficiently above the noise. The small amount to be measured and the noise are in some cases even of the same order of magnitude, and are therefore indistinguishable from one another. As a result, the measurements of small amounts (trace quantities) are inaccurate.

There is a need therefore to provide a method of analysing a sample which does not suffer from the above inaccuracies. The present invention aims to provide an improved sample analysis method and sample analysis device.

According to a first aspect of the present invention, there is provided a method of analysing a sample in which the combustion products are removed from the combustion chamber to a reservoir in which the combustion products are collected, after which the collected combustion products are fed from the reservoir to the measuring chamber.

This is advantageous, since a batch of combustion products is collected in the reservoir, after which said batch is measured in the measuring chamber. What is particularly advantageous is that the speed of measurement of the batch in the measuring chamber is independent of the speed of combustion in the combustion chamber. In the known method, a continuous flow of combustion products is measured, the measurement speed in the measuring chamber being coupled to the combustion speed. The speed of the combustion is limited because it is impossible to burn a sample more rapidly. The method according to the present invention makes it possible, however, to feed the combustion products more rapidly to the measuring chamber so that the measurement takes place in a shorter period of time. The measurement signal is stronger when the signal is extended over a longer period of time. The noise of the zero line is small compared with this stronger signal, which can therefore be measured more accurately. The measurement is more accurate for each component to be measured, such as sulphur or nitrogen. The sensitivity of the device according to the present invention is greater, while the analysis limit is lower.

In general, the sample is essentially completely burnt in the combustion chamber and all the combustion products formed are essentially collected in the reservoir. In addition, the combustion products may be conditioned between the combustion in the combustion chamber and the measurement in the measuring chamber. The conditioning comprises, for example, drying the combustion products and/or removing interfering components.

It is preferable that the reservoir is connected by a first connection to the combustion chamber and is connected by a second connection to the measuring chamber in such a way that, during the collection of the combustion products, the second connection to the measuring chamber is shut off and, during the feeding of the combustion products to the measuring chamber, the first connection to the combustion chamber is shut off.

Shutting off the connections to the combustion chamber or the measuring chamber, respectively, ensures that the combustion products are first completely collected in the reservoir without leakage to the measuring chamber and that, after the combustion, no combustion products can leak back to the combustion chamber. The combustion products cannot escape, with the result that all of the combustion products or virtually all of them are analysed.

It is possible for the speed with which the combustion products collected in the reservoir are fed to the measuring chamber to be higher than the speed with which the combustion products from the combustion chamber are removed to the reservoir. The speed of feeding to the measuring chamber can therefore be higher than the maximum speed of feeding to the reservoir, which is determined by the combustion speed in the combustion chamber.

To measure, for example, sulphur, one embodiment of the present invention is provided in which the measuring chamber has a discharge line for removing combustion products, which discharge line can be shut off by a valve and which discharge line is shut off during the feeding of the combustion products to the measuring chamber. Because the valve shuts off the measuring chamber during the feeding of the combustion products, the combustion products are collected under pressure in the measuring chamber. The sulphur is then measured. In this process, the signal achieves a maximum deflection, which is a measure of the amount of sulphur in the sample. That is, because the combustion products are fully collected in the reservoir 15 before undergoing measurements in the measuring chamber 16, all of the combustion products may be fed to the measuring chamber 16 together, so that the peak signal (maximum deflection) is representative of the total amount of sulphur in the combustion products. It is not then necessary to integrate the signal with respect to time. This leads to accurate measurement, even for small amounts.

According to a second aspect of the present invention, there is provided an analysis device for analysing a sample, the device comprising: a combustion chamber (2) arranged to combust the sample to produce combustion products; a reservoir (15) downstream of the combustion chamber (2) and arranged to collect the combustion products from the combustion chamber (2); a measuring chamber (16,30) downstream of the reservoir (15) and arranged to receive the combustion products from the reservoir (15) and to measure at least one property of the combustion products.

The analysis device improves the accuracy of the measurements of small amounts and a faster measurement is possible, as described above.

The analysis device preferably comprises shut-off means for shutting off the second connection to the measuring chamber during the collection of the combustion products and shutting off the first connection to the combustion chamber during the feeding of the combustion products to the measuring chamber. This maximizes the feed of combustion products to the measuring chamber.

The shut-off means of the analysis device preferably comprises a three-way stopcock that is connected to the first and second connection. The design of this embodiment is simple and reliable because only one opening in the reservoir is necessary. During the collection, said opening forms an inlet and during the measurement an outlet.

According to one embodiment of the analysis device, the reservoir comprises a cylinder in which a piston is movably incorporated. The cylinder has two chambers that are separated by the movable piston, wherein one of the chambers forms a filling chamber for collecting the combustion products, by means of which piston the combustion products can be forced out of the filling chamber.

One embodiment of the analysis device according to the present invention has the characteristic that the reservoir is confined by walls that are lined on the inside with a lining material that does not react with sulphur and/or nitrogen. Because the component to be measured does not react with the material of the reservoir, no component to be measured is lost. This has a favourable effect on the accuracy of the measurement.

According to a further aspect of the present invention, there is provided a method of analysing a sample, such as a fuel, comprising feeding the sample to a combustion chamber (2), the at least partial combustion of the sample in the combustion chamber (2) to combustion products, the removal of the combustion products from the combustion chamber (2), the feeding of the combustion products to a measuring chamber (16, 30) and the measurement of a component of the combustion products in the measuring chamber (16, 30), characterized in that the combustion products are removed from the combustion chamber (2) to a reservoir (15) in which the combustion products are collected, after which the collected combustion products are fed from the reservoir (15) to the measuring chamber (16, 30).

According to a further aspect of the present invention, there is provided an analysis device for analysing a sample, comprising a combustion chamber for at least partially burning the sample to form combustion products, which combustion chamber has an inlet opening for feeding the sample and has an outlet opening for removing the combustion products, and also a measuring chamber that is connected to the outlet opening of the combustion chamber, wherein the measuring chamber has measurement means for measuring a component of the combustion products. A reservoir is provided for the temporary collection of combustion products, which reservoir is connected by a first connection to the combustion chamber and is connected by a second connection to the measuring chamber.

Specific embodiments of the present invention will now be described, by way of example only, with reference to the accompanying drawings, in which:

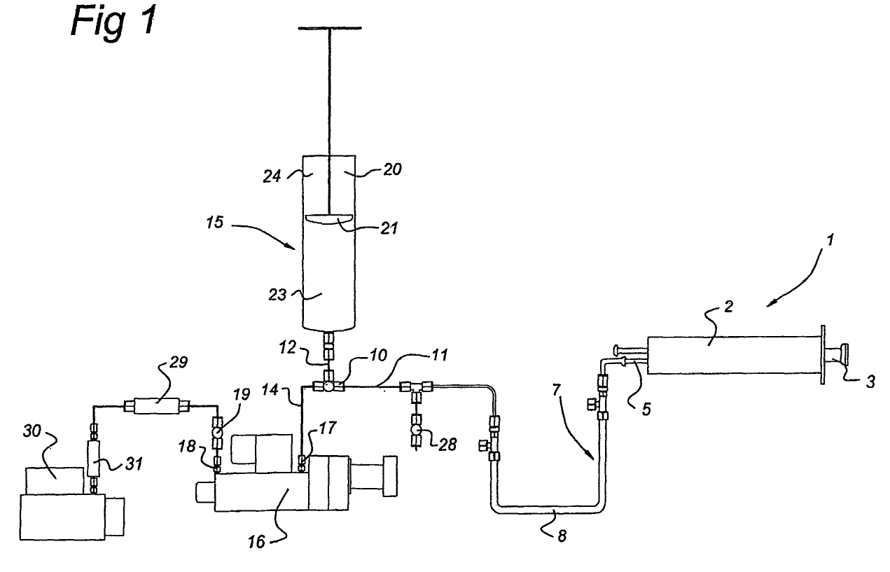

FIG. 1 shows a diagrammatic side elevation of an embodiment of the analysis device according to the invention;

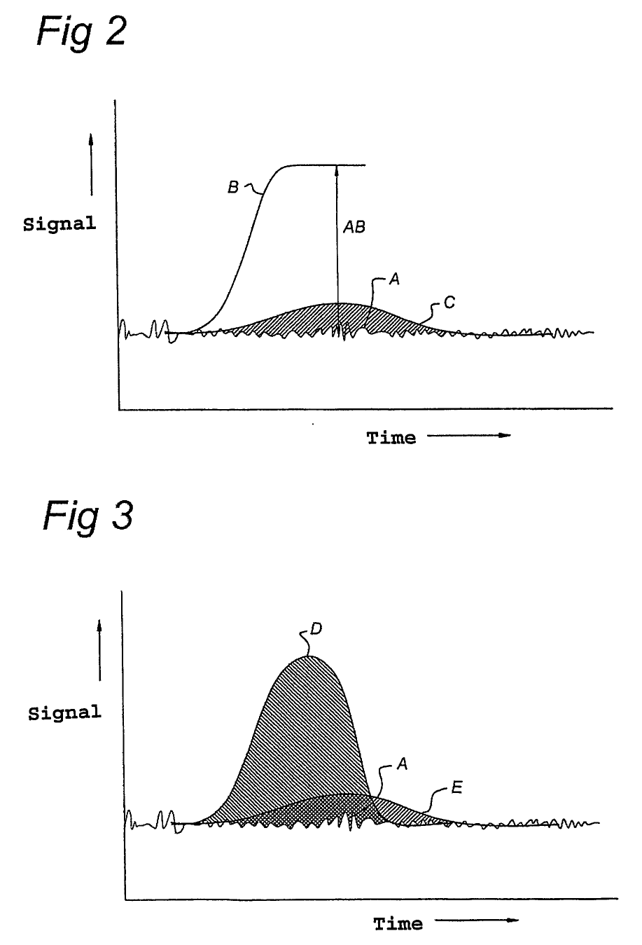

FIG. 2 shows a graph of a measurement of sulphur dioxide against time;

FIG. 3 shows a graph of a measurement of nitrogen dioxide against time.

An analysis device according to a first embodiment of the present invention is indicated in its entirety by 1 in FIG. 1. During operation, a basic flow of oxygen and/or an inert gas, such as argon, flows continuously through the analysis device 1. The basic flow provides reference conditions during each measurement of a component of the combustion products of a sample. The reference conditions form a zero line. Measurements are performed with respect to the zero line. The zero line, however, tends to be affected by noise as a consequence of fluctuations in the basic flow.

The analysis device 1 comprises a combustion chamber or furnace 2 that has an inlet opening 3 and an outlet opening 5. A sample of a product, such as petrol, can be brought into the combustion chamber 2 through the inlet opening 3. This sample may be a vaporous or gaseous, fluid or solid substance. The sample burns in the combustion chamber or furnace 2, preferably completely, to form combustion products, possibly with the aid of catalysts. The combustion products leave the combustion chamber 2 via the outlet opening 5.

The outlet opening 5 adjoins a conditioning unit 7. The conditioning unit 7 has a line 8 that is made of a material that can transport water out of the gas stream of the combustion products through the tube wall. The currently preferred material is a copolymer of tetrafluoroethylene and perfluoro-3,6-dioxa-4-methyl-7-octene-sulfonic acid, called Nafion®. Nafion® tubing suitable for use as line 8 is manufactured by Perma Pure LLC, New Jersey, USA. The line 8 is surrounded by an outer line in which dry gas flows in the opposite direction and entrains water that has diffused through the line 8 (not shown). This “dries” the combustion products.

The conditioning unit 7 is connected to a three-way stopcock 10 to which three lines 11, 12, 14 are connected. The line 11 is connected to the line 8 of the conditioning unit 7, i.e. the line 11 transports the combustion products originating from the combustion chamber 2. The line 12 is connected to a reservoir 15. The line 14 is connected to a measuring chamber 16.

Between the conditioning unit 7 and the stopcock 10 is a stopcock 28 that has a flushing and shut-off function. This can be used for cleaning the analysis device, for example.

During the combustion of the sample in the combustion chamber 2, the line 14 to the measuring chamber 16 is shut off by the three-way stopcock 10. The lines 11, 12 from the combustion chamber 2 or to the reservoir 15, respectively, are open.

The combustion products are collected in the reservoir 15. The reservoir 15 is formed as a cylinder in which a piston 21 is movable. The movable piston 21 divides the cylinder 20 into two chambers 23, 24. The chamber 24 on one side of the piston 21 is an empty chamber. The chamber 23 on the other side of the piston 21 forms a filling chamber that is filled with the combustion products.

During the collection of the combustion products, the piston 21 preferably moves to a position in which the filling chamber 23 is a maximum and the empty chamber 24 is a minimum. The combustion products can then readily flow into the reservoir. In one embodiment, the combustion products are drawn into the reservoir 15 by the opening action of the piston 21. Preferably, the combustion products are collected in the reservoir 15 throughout the combustion process.

After the combustion of the sample and the collection of the combustion products in the reservoir 15, the three-way stopcock 10 is reset. The stopcock 10 then shuts off the line 11 from the combustion chamber 2, while the lines 12, 14 from the reservoir 15 or to the measuring chamber 16, respectively, are open.

The piston 21 is then energized by a stepping motor (not shown) for forcing the combustion products out of the filling chamber 23. The combustion products 23 flow to the measuring chamber 16, which is, in this embodiment, equipped to measure the sulphur content of the combustion products.

The measuring chamber 16 has a feed line 17 connected to the line 14 and a discharge line 18. The discharge line can be shut off by a valve 19. While the combustion products are flowing through the feedline 17 into the measuring chamber 16, the valve 19 is closed. As the result, the combustion products are collected in the measuring chamber 16 under pressure.

The measuring chamber 16 has a UV light source for measuring sulphur dioxide that emits one or more light flashes after the combustion products have been collected in the measuring chamber 16. Preferably, the UV light source produces a number of pulses of light during this excitation process. For example, one UV light source which is currently preferred flashes at 8.7 pulses per second for the required excitation period.

The SO₂ present is brought to an excited state by the UV light. The sulphur dioxide is unstable in the excited state and will very quickly fall back to its ground state. In this process, energy is released in the form of light. The measuring chamber 16 therefore has, in addition, a light sensor for measuring the light emitted. The amount of light that is emitted provides a measure of the amount of SO₂ in the combustion gases, which corresponds to the sulphur content of the sample.

An exemplary measurement of the measuring chamber 16 is shown in FIG. 2. The line B shows the measurement of a batch that has been collected in the measuring chamber 16 from the reservoir 15. The distance AB between the maximum deflection of the line B and the zero line A indicates the amount of sulphur.

The line C shows a measurement according to the prior art in which the combustion products flow directly from the combustion chamber 2 to the measuring chamber 16 without the intervention of the reservoir 15. In this case, the amount of sulphur has to be determined by integration with respect to time. The hatched surface between the line C and the zero line A indicates the amount of sulphur (S).

The distance AB between the maximum deflection of the line B and the zero line A can be much more accurately determined than the hatched surface between the line C and the zero line A, especially as the sulphur content compared with the noise of the zero line is small. The measurement of the sulphur content of the sample according to the present embodiment is therefore more accurate.

After the measuring chamber 16, the combustion products are fed to a further measuring chamber 30. The measuring chamber 30 in this embodiment is equipped to measure the nitrogen content of the sample. The combustion products contain both nitrogen dioxide (NO₂) and nitrogen monoxide (NO). An NO converter 29, which is fitted upstream of the measuring chamber 30, first converts all the NO₂ essentially into NO. Furthermore, just upstream of the measuring chamber 30 is a feed unit 31 that feeds ozone (O₃) to the combustion products. The nitrogen monoxide (NO) reacts with the ozone, in which process nitrogen dioxide is formed in an excited state (NO₂*). The measuring chamber 30 has a light sensor for detecting light that is emitted while falling back from the excited state (NO₂*) to the ground state. The amount of light emitted provides a measure of the amount of NO in the combustion gases, which again corresponds to the amount of nitrogen (N) in the sample.

An exemplary measurement of the measuring chamber 30 is shown in FIG. 3. The line D shows the measurement of a batch that is fed from the reservoir 15 via the measuring chamber 16 to the measuring chamber 30. The speed with which the combustion products flow into the measuring chamber 30 is relatively high. Said speed is not coupled to the relatively slow combustion speed.

The line E shows a measurement according to the prior art in which the combustion products flow directly from the combustion chamber 2 to the measuring chamber 30 without the intervention of the reservoir 15. The flow speed of the combustion products to the measuring chamber 30 is in this case certainly limited by the combustion speed in the combustion chamber 2. The prior art measurement accordingly extends over a longer period of time.

The hatched surface between the lines D and E respectively and the zero line A indicates the amount of nitrogen (N). The hatched surface between the line D and the zero line A can be determined more accurately than the hatched surface between the line E and the zero line A. The region before and after the peak in the measurement, at which the measurement is hardly above the noise, is indeed smaller at the line D. The peak in the measurement is also narrower.

If it is not desired to use the reservoir 15, the stopcock 10 can assume a position in which the line 12 from and to the reservoir 15 is shut off. The combustion products flow in that case directly from the combustion chamber 2 to the measuring chamber 16, as is known from the prior art.

Incidentally, the analysis device shown in the figure is only one exemplary embodiment. The analysis device according to the invention may, for example, comprise only a single measuring chamber, which measuring chamber can be a measuring chamber 16 for sulphur or a measuring chamber 30 for nitrogen or a measuring chamber for still another component. It is also possible to replace the three-way stopcock with the line to the reservoir by two two-way stopcocks and two lines from or to, respectively, the reservoir.

In addition, the various light sensors described above are preferably provided by one or more respective photomultiplier tubes. Nevertheless, any other suitable type of light sensor may alternatively be employed.

1. A method of analysing a sample, comprising:
combusting the sample in a combustion chamber (2) to produce combustion products;
collecting the combustion products from the combustion chamber (2) into a reservoir (15) comprising a gas displacer;
operating the gas displacer to force the collected combustion products out of the reservoir (15) to a measuring chamber (16,30) under pressure; and
measuring at least one property of the combustion products in the measuring chamber (16,30).

2. The method according to claim 1, wherein the reservoir (15) is connected by a first connection (11) to the combustion chamber (2) and is connected by a second connection (14) to the measuring chamber (16, 30), comprising shutting off the second connection (14) to the measuring chamber (16, 30) during the collection of the combustion products and shutting off the first connection (11) to the combustion chamber (2) during the feeding of the combustion products to the measuring chamber (16, 30).

3. The method according to claim 1, wherein the speed with which the combustion products collected in the reservoir (15) are fed to the measuring chamber (16, 30) is higher than the speed with which the combustion products are removed from the combustion chamber to the reservoir (15).

4. The method according to claim 1, wherein the measuring chamber (16, 30) has a discharge line (18) for removing combustion products, further comprising shutting off the discharge line (18) during the feeding of the combustion products to the measuring chamber (16, 30).

5. The method according to claim 4, wherein substantially all of the combustion products are forced into the measuring chamber (16,30) prior to the measurement step.

6. The method according to claim 1, wherein the sample is substantially completely burnt in the combustion chamber (2) and substantially all the combustion products formed are collected in the reservoir (15).

7. The method according to claim 1, comprising the conditioning of the combustion products between combustion in the combustion chamber (2) and measurement in the measuring chamber (16, 30).

8. The method according to claim 7, wherein the conditioning comprises drying the combustion products.

9. The method according to claim 1, wherein the combustion products are collected into the reservoir (15) while the sample is being combusted.

10. The method according to claim 1, wherein the combustion products are provided to the measuring chamber (16,30) once substantially all of the combustion products have been collected into the reservoir (15).

11. The method according to claim 1, wherein the gas displacer comprises a piston (21) movably incorporated in the reservoir (15).

12. The method according to claim 11, wherein the combustion products are drawn into the reservoir (15) by the opening action of the piston (21).

13. An analysis device for analysing a sample, the device comprising:
a combustion chamber (2) arranged to combust the sample to produce combustion products;
a reservoir (15) comprising a gas displacer, the reservoir being downstream of the combustion chamber (2) and arranged to collect the combustion products from the combustion chamber (2); and
a measuring chamber (16,30) downstream of the reservoir (15) and arranged to receive the collected combustion products from the reservoir (15) and to measure at least one property of the combustion products,
wherein the gas displacer is operable to force the collected combustion products out of the reservoir (15) to the measuring chamber (16,30) under pressure.

14. The analysis device according to claim 13, wherein the combustion chamber (2) has an inlet opening (3) for feeding the sample and has an outlet opening (5) for removing the combustion products.

15. The analysis device according to claim 14, wherein the measuring chamber (16, 30) is connected to the outlet opening (5) of the combustion chamber (2) and the reservoir (15) is connected by a first connection (11) to the combustion chamber (2) and is connected by a second connection (14) to the measuring chamber (16, 30).

16. The analysis device according to claim 13, wherein the measuring chamber (16, 30) has measurement means for measuring the at least one property of the combustion products.

17. The analysis device according to claim 15, wherein shut-off means (10) are provided for shutting off the second connection (14) to the measuring chamber (16, 30) during the collection of the combustion products and shutting off the first connection (11) to the combustion chamber (2) during the feeding of the combustion products to the measuring chamber (16, 30).

18. The analysis device according to claim 17, wherein the shut-off means comprises a three-way stopcock (10) that is connected to the first and second connection (11, 14).

19. The analysis device according to claim 13, wherein the measuring chamber (16, 30) has a discharge line (18) for removing combustion products, which discharge line (18) can be shut off by a valve (19).

20. The analysis device according to claim 13, wherein the gas displacer comprises a cylinder (20) in which a piston (21) is movably incorporated.

21. The analysis device according to claim 20, wherein the cylinder (20) comprises two chambers (23, 24) separated by the movable piston (21), wherein one of the chambers forms a filling space (23) for the collection of the combustion products and the piston (21) can be energized by a stepping motor in one direction to force the combustion products out of the filling chamber (23).

22. The analysis device according to claim 13, wherein the reservoir (15) is confined by walls that are lined on the inside with a lining material that does not react with sulphur and/or nitrogen.

23. The analysis device according to claim 13, wherein a conditioning unit (7) for conditioning the combustion products is fitted between the combustion chamber (2) and the measuring chamber (16, 30).

24. The analysis device according to claim 23, wherein the conditioning unit (7) comprises a tube (8) that is made of a material through which water can diffuse.

25. The analysis device according to claim 24, wherein the material is a copolymer such as Nafion®.

26. The analysis device according to claim 13 comprising a gas source for continuously passing a gas through the analysis device.

27. The analysis device according to claim 26, wherein the gas comprises oxygen and/or an inert gas, such as argon.

28. A method of analysing a sample, such as a fuel, comprising feeding the sample to a combustion chamber (2), the at least partial combustion of the sample in the combustion chamber (2) to combustion products, the removal of the combustion products from the combustion chamber (2), the feeding of the combustion products to a measuring chamber (16, 30) and the measurement of a component of the combustion products in the measuring chamber (16, 30), characterized in that the combustion products are removed from the combustion chamber (2) to a reservoir (15) comprising a gas displacer, the combustion products being collected in the reservoir (15), after which the gas displacer is operated to force the collected combustion products out of the reservoir (15) to the measuring chamber (16, 30) under pressure.

29. An analysis device for analysing a sample, comprising a combustion chamber (2) for at least partially burning the sample to combustion products, which combustion chamber (2) has an inlet opening (3) for feeding the sample and has an outlet opening (5) for removing the combustion products, and also a measuring chamber (16, 30) that is connected to the outlet opening (5) of the combustion chamber (2), wherein the measuring chamber (16, 30) has measurement means for measuring a component of the combustion products, characterized in that a reservoir (15) is provided for the temporary collection of the combustion products, which reservoir is connected by a first connection (11) to the combustion chamber (2) and is connected by a second connection (14) to the measuring chamber (16, 30), the reservoir comprising a gas displacer operable to force the collected combustion products out of the reservoir (15) to the measuring chamber (16,30) under pressure.
